(19) United States
(12) Patent Application Publication
(10) Pub. No.: US 2018/0314680 A1
(43) Pub. Date: Nov. 1, 2018

(54) MANAGING CHANGES SINCE LAST ACCESS FOR EACH USER FOR COLLABORATIVELY EDITED ELECTRONIC DOCUMENTS

(71) Applicant: Microsoft Technology Licensing, LLC, Redmond, WA (US)

(72) Inventors: Amal DORAI, San Jose, CA (US); Taili FENG, Bellevue, WA (US); Matthew Charles GAUTHIER, Redmond, WA (US); Alyssa Marie IRWIN, Seattle, WA (US); Douglas Lane MILVANEY, Somerville, MA (US); Gaurav MISHRA, Redmond, WA (US); Manasi VELHANKAR, Redmond, WA (US); Joan WEAVER, Somerville, MA (US)

(21) Appl. No.: 15/582,598

(22) Filed: Apr. 28, 2017

(51) Int. Cl. G06F 17/22; G06F 17/24; G06F 17/30

(52) U.S. Cl. CPC G06F 17/2288; G06F 17/2205; G06F 3/04855; G06F 17/30011; G06F 17/30203; G06F 17/24

(57) ABSTRACT

Using stored information about the content of an electronic document which an end user has accessed, and information about changes made by other users to the electronic document, when the end user accesses a server computer from any device, the server computer can identify changed content in the electronic document which the end user has not yet accessed. When the server computer delivers the electronic document to the device used by the end user, the electronic document can be accompanied by information indicating which content of the electronic document the end user has not yet accessed. An end user application on the device can present the electronic document with information indicating the content which that end user has not yet accessed. By storing this information on the server computer, the end user can access the electronic document from any device and quickly identify the changed content which that end user has not yet accessed.

### BACKGROUND

The availability of shared storage systems for electronic documents has increased the ability of computer end users to share and to collaborate in the creation of a variety of electronic documents. End users can cause electronic documents to be stored in a shared storage system that is accessible on a computer network, such as the internet. End users can instruct such a shared storage system to allow electronic documents to be shared with other end users of the shared storage system. A shared storage system generally has an access control component in a file system that tracks, for each electronic document, access rights that different end users have for the electronic document.

After an electronic document has been shared among two or more end users, the shared storage system manages access to the shared electronic document to ensure consistency of the electronic document, especially in the case of collaborative editing of, i.e., collaborative modifications to, the electronic document. In some implementations, a collaboration system works with the shared storage system to manage collaborative editing by tracking which end users currently are using end user applications on client computers to access the same electronic document. The collaboration system typically is implemented as one or more computer programs executing on one or more server computers, and, in some implementations, may have components executing on the client computers.

An end user application running on a computer, used to modify electronic documents, typically is configured to allow an editor to perform a variety of actions related to electronic documents. For example, an end user may take actions with respect to an electronic document, such as opening, saving, printing, presenting, closing or sharing an electronic document, and so on. As another example, an end user may take actions that modify the electronic document, thus modifying either its structure or content or both, such as creating, deleting or updating structure and/or content. As another example, a user may take actions with respect to comments in an electronic document, such as adding, editing, or deleting a comment, replying to a comment, or marking a comment as resolved or unresolved. Adding a comment can involve associating a comment with a location within the electronic document or within a general comment section of the electronic document. Any single editor may add multiple comments to an electronic document. When the electronic document is shared, such comments can originate from multiple editors using multiple end user applications.

End users and applications can also take actions related to electronic documents outside of the collaborative editing system. For example, actions may be taken by or through a shared storage system or by or through a communication application. For example, through the shared storage system, a user may take an action with respect to an electronic document, such as deleting, sharing, renaming, moving, or copying it, or changing its permissions, and the like. As another example, a communication application may transmit a copy of an electronic document, or save an electronic document. Yet other applications may access an electronic document, such as for reading and/or printing.

Tracking information about the actions performed by end users in collaboration systems, with many end users and many electronic documents, can result in a large amount of data being stored about user activity. When an end user accesses an electronic document, which has been shared and is in the process of being edited collaboratively, the amount of data stored about user activity for the electronic document can become unwieldy and make it difficult for the end user to locate and review relevant changes, particularly new or previously unseen changes to content of the electronic document, made by other users since the last time the end user viewed the document.

### SUMMARY

This Summary is provided to introduce a selection of concepts in a simplified form that are further described below in the Detailed Description. This Summary is intended neither to identify key or essential features, nor to limit the scope, of the claimed subject matter.

A server computer, in a computer system supporting collaborative editing, stores information about sharing status of an electronic document which includes an identifier for each end user with whom the document is shared, and an indication of content of the electronic document which the end user has accessed. The content of the electronic document which the end user has accessed can be derived from one or more pieces of information. For example, the server computer can store a time stamp for an end user for an electronic document indicating when the end user last accessed the electronic document. As another example, the server computer can store identifiers related to content of the electronic document which has been accessed by the end user, such as a version identifier or other identifiers of content with the electronic document. As another example, the server computer can store activity data indicating actions taken by end users with respect to the electronic document; the server computer can store an activity identifier for the last action for which activity data was accessed for an end user.

The server computer also stores information about changes made to an electronic document. For example, this information can include the activity data describing actions taken by users with respect to the electronic document. As another example, this information can include a revision history indicating changes made over time to the electronic document. As another example, this information can include different versions of the electronic document stored over time. As another example, this information can include associating identifiers with structure and/or content of the electronic document, and other data indicating a time at which the structure and/or content was last stored, or an identifier of a save operation that last changed the structure and/or content.

Using the stored information about the content of the electronic document which the end user has accessed, and the information about changes made to the electronic document, when an end user accesses the server computer from any device, the server computer can determine which content of the electronic document the end user has not yet accessed. When the server computer delivers the electronic document to the device used by the end user, the electronic document can be accompanied by information indicating which content of the electronic document the end user has not yet accessed. An end user application on the device can present the electronic document to the end user along with information indicating the changes to the content which that end user has not yet accessed. By storing this information on the server computer, the end user can access the electronic document from any device and have the most up to date information about the content which that end user has not yet accessed.

In the following description, reference is made to the accompanying drawings which form a part hereof, and in which are shown, by way of illustration, specific example implementations. Other implementations may be made without departing from the scope of the disclosure.

### BRIEF DESCRIPTION OF THE DRAWINGS

FIG. 1 is a block diagram of an example computer system configured to support collaborative editing of electronic documents through end user applications on multiple client computers.

FIG. 2 is a diagram of an illustrative example of data structures for storing data for an electronic document.

FIG. 3 is an illustration of an example graphical user interface for displaying an electronic document in an end user application.

FIG. 4 is a data flow diagram of an illustrative example of a client computer with an end user application.

FIG. 5 is a data flow diagram of an illustrative example of a server computer configured to store electronic documents and make electronic documents available to client computers for end users.

FIG. 6 is a flowchart of operation of an example implementation of opening a document by an end user application.

FIG. 7 is a flowchart of operation of an example implementation of retrieving a document by a server computer.

FIG. 8 is a block diagram of an example computer.

### DETAILED DESCRIPTION

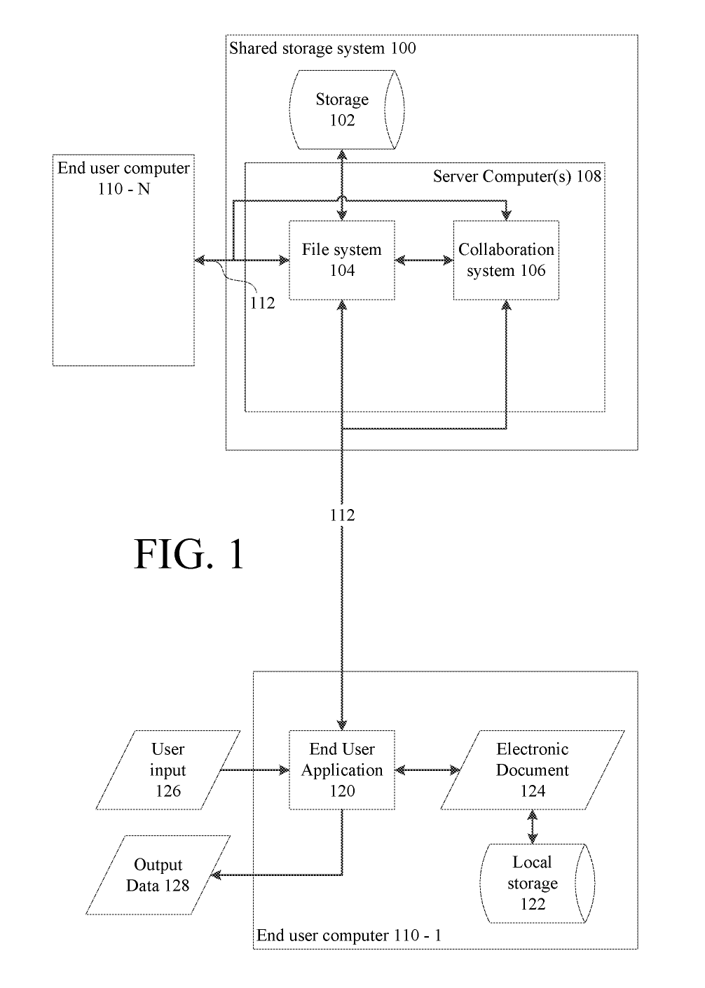

FIG. 1 is a block diagram of an example computer system configured to support sharing of electronic documents among end users, and collaborative editing of electronic documents by multiple end users through end user applications on multiple client computers.

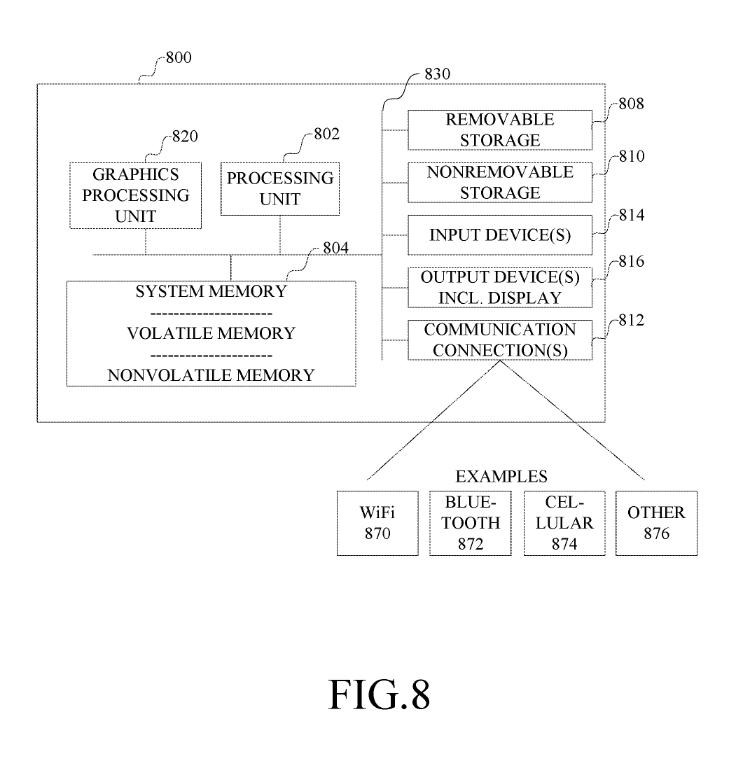

Such a computer system can include a shared storage system 100. The shared storage system 100 generally includes storage 102 in which data is stored in data files on a computer storage device accessible through a file system 104 that is part of the shared storage system. The file system configures one or more server computers 108 to store and maintain information about each file stored in the storage 102. The shared storage system 100 can be implemented using one or more general purpose computers, such as described in connection with FIG. 8, configured to implement one or more server computers. The shared storage system 100 is responsive to requests from end user computers 110 over one or more computer network(s) 112 to access, through the file system 104, files on the storage 102.

Multiple end user computers 110-1 to 110-N, also called client computers herein, are connected to the shared storage system for communication over one or more computer networks 112, such as the internet or a private computer network. An end user computer 110 can be implemented using a general-purpose computer, such as described in connection with FIG. 8, configured as a client computer running one or more end user applications 120 or yet other applications (not shown). Examples of such a computer include, but are not limited to, a tablet computer, a slate computer, a notebook computer, a desktop computer, a virtual desktop computer hosted on a server computer, a handheld computer, game console, and a mobile phone including a computer and applications.

The computer network(s) 112 can be any computer network supporting interaction between the end user computers and the shared storage system, such as a local area network or a wide area network, whether private and/or publicly accessible, and can include wired and/or wireless connectivity. The computer network can be implemented using any of several available network communication protocols, including but not limited to Ethernet and TCP/IP.

An end user computer 110 can include one or more end user applications 120. In this context, an end user application is a computer program executed on the end user computer that configures the computer to be responsive to user input 126 to allow an end user to interactively modify an electronic document 124. An electronic document can include any kind of data, such as text, still images, video, or audio and combinations of these, and generally has data defining structure of the electronic document and data defining content of the electronic document within the defined structure. The end user application processes the electronic document in response to user input 126 received from input devices. For example, the end user application combines data to create the structure and content of the electronic document. The end user application also displays or otherwise presents output data 128, such as a graphical user interface including the content according to the structure of the electronic document, through output devices (not shown) to the end user. The end user application also stores the electronic document in memory and/or in a data file in local storage 122 of the end user computer and/or in the shared storage system 100.

A variety of kinds of end user applications can be used on an end user computer. Examples of an end user application include, but are not limited to, a word processing application, a presentation application, a note taking application, a text editing application, a paint application, an image editing application, a spreadsheet application, a desktop publishing application, a drawing application, a video editing application, and an audio editing application. An end user application can permit a variety of operations on an electronic document, such as, but not limited to, viewing and commenting without content editing, viewing and content editing, or viewing only.

As noted above, an end user application 120 generates an electronic document 124 that is stored in a data file, which can be stored in local storage 122 and/or the shared storage system 100. The electronic document, while being modified by an end user on the end user computer, also is temporarily stored in memory on the end user computer. The end user application also may temporarily store the electronic document in a cache on local storage before committing changes to the electronic document to the data file. The client computer may have an application that coordinates with the shared storage system 100 to save the electronic document on the shared storage system 100.

For an electronic document stored in a data file in a shared storage system 100, the file system 104 of the shared storage system can include information indicating a sharing state of the electronic document. Such information can be in the form of access controls indicating which end users are authorized to access the electronic document and its related data. Such information also can include an indication of content of the electronic document which the end user has accessed.

The file system 104 also can be configured to be responsive to a query to provide this information to another application associated with the shared storage system, such as a collaboration system 106 or other service on the shared storage system, or applications on end user computers, such as an end user application 120 or other application. The file system 104 also can provide a mechanism to change the sharing state of an electronic document, either directly through the shared storage system or indirectly through another application, in several ways.

In some implementations, electronic documents also can be shared by users by distributing a copy of the electronic document through various distribution channels among multiple users. Such sharing generally involves an application accessing the electronic document through the file system 104 to obtain either a copy of the electronic document or a resource identifier, such as a uniform resource identifier or file name, for accessing the electronic document through the shared storage system 100.

In some implementations, when an electronic document stored in the shared storage system is shared, with modification rights, with multiple end users, two or more end user applications on two or more client computers can access and can attempt to modify the electronic document through the shared storage system 100. A single end user may access the same document using two or more client computers and two or more end user applications. To handle such a condition, the shared storage system can include a collaboration system 106. The collaboration system 106 is a computer program that configures the server computer to manage contemporaneous access to shared electronic documents in the shared storage system 100. The collaboration system 106 may store information about end user applications, and associated end users, that currently are accessing the electronic document.

Using the information about end user applications and end users currently accessing an electronic document, the collaboration system can implement any of several different techniques for coordinating access to the electronic document to ensure consistency of the electronic document. For example, the collaboration system can prevent one end user application from causing modifications to be written to a data file for an electronic document while another the data file is open for writing by another end user application. As another example, the collaboration system can interactively merge changes to the electronic document as such changes are being made collaboratively through multiple end user applications. In such a case, as an example, the collaboration system can merge changes received from end user computers in memory local to the collaboration system, and then can transmit a modified version of the electronic document to each end user computer with an application currently accessing the document.

The collaboration system or the shared storage system can track information indicating content of the electronic document which the end user has accessed. This indication of the content of electronic document of which the end user has accessed can be derived from one or more pieces of information. For example, the server computer can store a time stamp for an end user for an electronic document indicating when the end user last accessed the electronic document. As another example, the server computer can store identifiers related to content of the electronic document which has been accessed by the end user, such as a version identifier or other identifiers of content with an electronic document.

The end user application 120 running on an end user computer 110, used to modify electronic documents, typically is configured to allow an editor to perform a variety of actions related to electronic documents. Generally, each user can modify the electronic document, possibly adding comments to the electronic document and performing other actions with respect to the document, and then can share the modified electronic document with additional users. For example, an end user may take actions with respect to an electronic document, such as opening, saving, printing, presenting, closing, or sharing an electronic document, and so on. As another example, an end user may take actions that modify the electronic document, thus modifying either its structure or content or both, such as creating, deleting or updating structure and/or content, and/or updates to activity data associated with the electronic document. As another example, a user may take actions with respect to comments in an electronic document, such as adding, editing, or deleting a comment, replying to a comment, or marking a comment as resolved or unresolved. Adding a comment can involve associating a comment with a location within the electronic document or within a general comment section of the electronic document. Any single editor may add multiple comments to an electronic document. When the electronic document is shared, such comments can originate from multiple editors using multiple end user applications.

End users and applications can also take actions related to electronic documents outside of the collaborative editing system. For example, actions may be taken by or through a shared storage system or by or through a communication application. For example, through the shared storage system, a user may take an action with respect to an electronic document, such as deleting, sharing, renaming, moving, or copying it, or changing its permissions, and the like. As another example, a communication application may transmit a copy of an electronic document, or save an electronic document. Yet other applications may access an electronic document, such as for reading and/or printing.

As multiple end users use an electronic document, activity data associated with that electronic document can grow significantly. There also are a variety of formats in which data about the changes made to an electronic document can be stored. For example, this information can include activity data, describing actions taken by users with respect to the electronic document. As another example, this information can include a revision history indicating changes made over time to the electronic document. As another example, this information can include different versions of the electronic document stored over time. As another example, this information can include associating identifiers with structure and/or content of the electronic document, and other data indicating a time at which the structure and/or content was last stored, or an identifier of a save operation that last changed the structure and/or content.

However, when an end user opens an electronic document, whether to modify the electronic document or simply to review it, information about changes or activity data can be too voluminous or otherwise inadequate to allow the end user to understand quickly what has changed in the electronic document since that electronic document was last viewed. Also, the end user may access the electronic document with multiple devices. For example, an end user may access an electronic document from a desktop computer with a desktop-based end user application while at an office, and then access the electronic document from a mobile device, such as a tablet, with a mobile version of the end user application, or a different end user application. Information stored locally on each of the multiple client computers for a single end user would not allow the end user, using one device, to understand quickly what has changed in the electronic document since that document was last viewed if the viewing occurred on another device.

Using the stored information about the content of the electronic document which the end user has accessed, and the information about changes made to the electronic document, a server computer can determine which content of the electronic document the end user has not yet accessed. When an end user accesses the server computer from any device, the server computer identifies this content and delivers the electronic document to the device used by the end user. By storing this information on the server computer, the end user can access the electronic document from any device and have the most up to date information about the content which that end user has not yet accessed. When returned to the end user computer, the electronic document can be accompanied by information indicating which content of the electronic document the end user has not yet accessed. An end user application on the device can present the electronic document with information indicating the content which that end user has not yet accessed. The end user application also can provide navigational and visual aids to an end user, allowing the user to quickly navigate the electronic document and catch up on changes made to that electronic document. Processing by the end user application of the electronic document, due to navigation and rendering in response to end user input, can be reduced by indicating the content which that end user has not yet accessed. Processing by the end user application of the electronic document also can be reduced by generating the change data on the server computer.

How the server computer determines which content of the electronic document the end user has not yet accessed depends on how the server computer tracks any indication of content of the electronic document which the end user has accessed and information about changes made to an electronic document. A few example implementations will now be described.

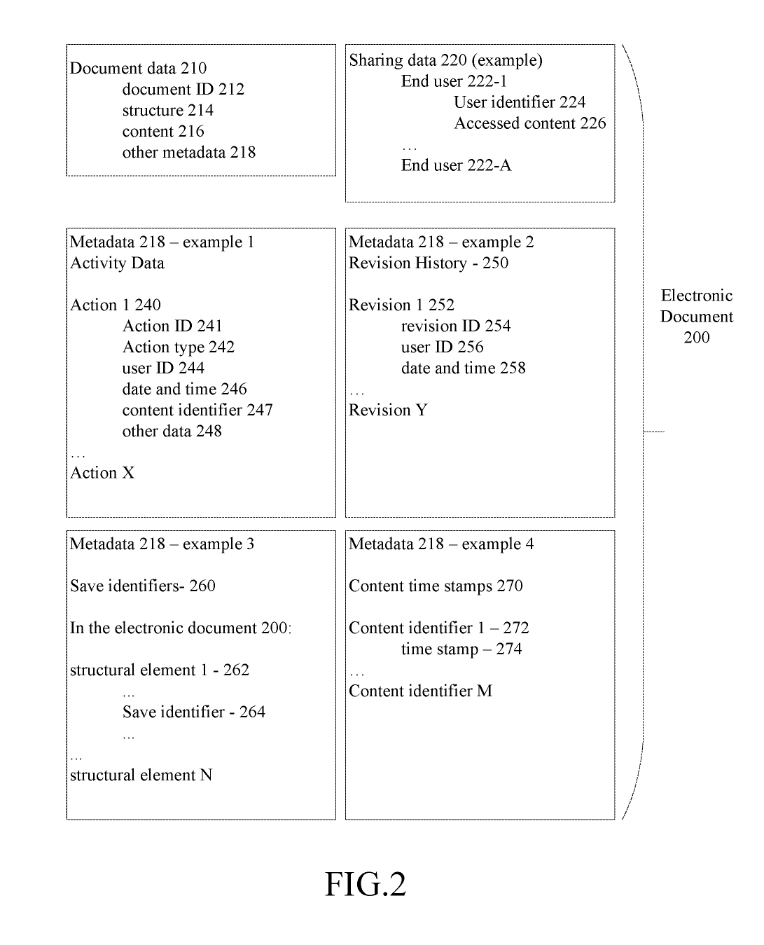

One example implementation of the shared storage system, collaborative editing system, and corresponding end user application, will now be described in connection with FIGS. 2-7. It should be understood that this is just one example implementation, and that many other implementations are possible.

The data representing an electronic document can be stored in computer storage in any of several different formats. On the one hand, there can be a file format for one or more data files for storing data for an electronic document in persistent storage. On the other hand, there can be one or more data structures stored in memory for providing access to the data for the electronic document by an end user application during editing or viewing of the electronic document. Some data also can be stored in a database. The file format can be and typically is different from the data structure that is stored in memory or other database, yet these structures generally store the same data.

When an application, such as an application or service on the server computer or an end user application on a client computer, reads data (such as shown in FIG. 2) for an electronic document, the application may generate corresponding data structures in memory. In an end user application, such data in the data structures can be modified in memory in response to user actions. The end user application in turn processes and stores the data structures into the data files at periodic intervals and/or in response to an instruction received from an end user. In response to saving the electronic document, the server computer updates the data structures and data files the server computer maintains for the electronic document.

An example implementation of data representing an electronic document will now be described in connection with FIG. 2. In FIG. 2, in general, and whether in a data file in persistent storage or data structure in memory, the data 200 for the electronic document includes document data 210, representing structure, content and metadata of the electronic document, and sharing data 220 representing at least end users associated with the electronic document, such as the end users permitted to access the electronic document. The document data 210 and sharing data 220 can be stored in the same data file, or in separate data files. The sharing data 220 can be stored in a database or in another data structure in memory or in persistent storage. The sharing data 220, when stored by a server computer, allows a client application to query the server computer about whether an end user is permitted to access an electronic document.

The sharing data 220 can include, for an electronic document, data about end users 222-1 to 222-N authorized to access the electronic document, which can include a user identifier 224 representing the end user, and data 226 indicating content of the electronic document which the end user has accessed. There are several ways in which data relating users and documents can be stored, including but not limited to, associating user identifiers with data about each document, associating document identifiers with data about each user, or storing data associating document identifiers and user identifiers.

The data 226, which indicates content of the electronic document which the end user has accessed, can include information from which the server computer can derive which content of electronic document the end user has accessed. For example, the server computer can store a time stamp for an end user for an electronic document indicating when the end user last accessed the electronic document. As another example, the server computer can store an activity identifier for the last action with respect to the electronic document for which the activity data was accessed for the end user. As another example, the server computer can store one or more identifiers related to content of the electronic document which has been accessed by the end user. Examples of such identifiers include a version identifier for a version of the electronic document, an identifier of content or structure within the electronic document, or an identifier of an operation, such as a save operation, associated with one or more items of content or structure within the electronic document.

The document data 210 can include one or more data files that store the structure and content of the electronic document, and metadata associated with the electronic document, such as version information, comment data representing structure and content of comments applied to the electronic document, and activity data representing actions related to the electronic document taken by end users.

The document data 210 for the electronic document includes a document identifier 212, data defining the structure 214 of the electronic document, and data defining the content 216 within that structure of the electronic document. There are several formats for electronic documents, including various markup languages, such as the hypertext markup language (HTML), standard generalized markup language (SGML), extensible markup language (XML), as well as proprietary document formats. The invention is not limited to any particular format for the structure and content of the electronic document. The data for an electronic document may include references to other data related to the electronic document, such as comment data, activity data, style sheets for formatting the document, templates, macros and the like. For example, comment data can include, for each comment, a reference to a location within the electronic document, a user identifier of the end user that added the comment, and content of the comment. Such data may be stored in the same file as the structure and content of the electronic document, or in a separate file.

The data for an electronic document also includes metadata 218 about the electronic document from which information about changes made to an electronic document can be determined. There are several possible implementations of such data, and some examples of these are described in more detail below.

In one implementation, the metadata 218 can be a reference to activity data defining a collection of actions 240 associated with an electronic document. Such activity data can include a document identifier indicating the electronic document to which the collection of actions is related if the activity data is stored separately from the electronic document. The activity data can include, for an action 240, an action identifier 241, data indicating a type of action 242, a user identifier 244 of the end user associated with the action, and a date and time stamp 246 indicating when the action occurred. The user identifier can be any indication of a user, such as an email address, user name, etc., such as the user name for the user to access the shared storage system that stores the electronic document. The type of action 242 can indicate, for example, whether the action is a type of action with respect to the electronic document, a type of action with respect structure and/or content, activity data, or comment data, or other type of action. A content identifier 247 also can be included to identify a section of the electronic document to which the activity applies. This identifier 247 can be, for example, an identifier of a revision in a revision history, a content identifier, an identifier for an element of the structure of the electronic document, a save identifier, or other identifier related to the content of the electronic document. Other data 248, such as text or other information, or information about the end user application being used for the action, can be stored as part of the data describing the action 240.

The activity data can represent various kinds of actions performed by users through the end user application and associated with the electronic document. Such actions can include actions with respect to an electronic document, for example, opening, saving, printing, presenting, closing or sharing an electronic document, and so on. As another example, an end user may take actions that modify the electronic document, thus modifying either its structure or content or both, such as creating, deleting or updating structure and/or content, and/or updates to activity data associated with the electronic document. An action also can be associated with a location within the document, such as a comment, such as adding, editing, or deleting a comment, replying to a comment, or marking a comment as resolved or unresolved. A mention of another individual also can be associated with a location in the document, which is another form of content-related activity. Actions also can include other types of actions, such as messages between or among users associated with the electronic document, which are not associated with a location in the electronic document. Such actions, e.g., messages, are another form of document-related activity. The activity data as stored on the server computer can include activities occurring through the file system or other applications not interacting through the collaborative editing system. In such a case, the activity data can represent a large range of possible actions related to a document.

Such activity data can be used to determine changes made to content of an electronic document since a user's last access of a document by filtering the activity data by type of action and by actions occurring after the time of last access to the electronic document. The time of last access may be, for example, a time stamp or an activity identifier for the electronic document which was last accessed by the end user, or other data from which the time of last access can be inferred.

As another example implementation, the metadata 218 can include a revision history 250. A revision history can be a time-ordered list of revisions 252 of the electronic document. A revision identifier 254, such as file name that stores the data for the revision, is associated with other data. Example data stored about each revision can include, for example, a user identifier 256 for a user that generated the revision and a time stamp 258 for the revision.

In one example implementation, each version of an electronic document can be stored in a separate data file and each revision in the revision history refers to a different data file for the electronic document. To identify changes to an electronic document which a given user has not yet accessed, one can access the revision associated with a time stamp or other indication of the given user's last access, and compare the current version to that last version.

A revision history alternatively can be a time-ordered list of fine-grained changes made to the content and/or structure of the electronic document. In such an implementation, the document version at a given time is a combination of all changes through that given time. The changes may be stored in one or more data files or in a database. Data stored for a revision in the revision history may include an indication of the change to the content or structure of the electronic document.

As another example implementation shown at 260, the metadata 218 can include storing identifiers of save operations with changed content saved during that save operation. Such data may be stored, for example, within the electronic document. For example, each structural element 262 in the electronic document may have an associated identifier 264 indicating when that structural element was last saved with a change, herein called a “save identifier”. When the electronic document is saved with any changes, a new save identifier is generated and is associated with those changes. An electronic document with save identifiers can be scanned to identify all save identifiers referenced within the document. When the electronic document is opened, saved, or closed for a user, the save identifiers in the electronic document at that time can be stored as an indication of the changes accessed by that end user. As multiple users modify the electronic document over time, the save identifiers in the electronic document and the save identifiers stored for each user allow the server computer to identify any changes in an electronic document which have not been accessed by a given user

As another example implementation shown at 270, the metadata 218 can include data associating identifiers of content or structure within the electronic document with time stamps. The content time stamps 270 include, for each content identifier 272, at least a time stamp 274 indicating when that content identifier was last changed. Such data can be stored in the same data file as the electronic document. In such an implementation, for each user, the accessed content 226 can be a similar list of content identifiers and time stamps. To identify the content that has changed since a given user's last access, the list of content identifiers 270 can be compared to the list of content identifiers stored as data 226 to identify new content identifiers and content identifiers having time stamps 274 later than the time stamps stored for the user in data 226.

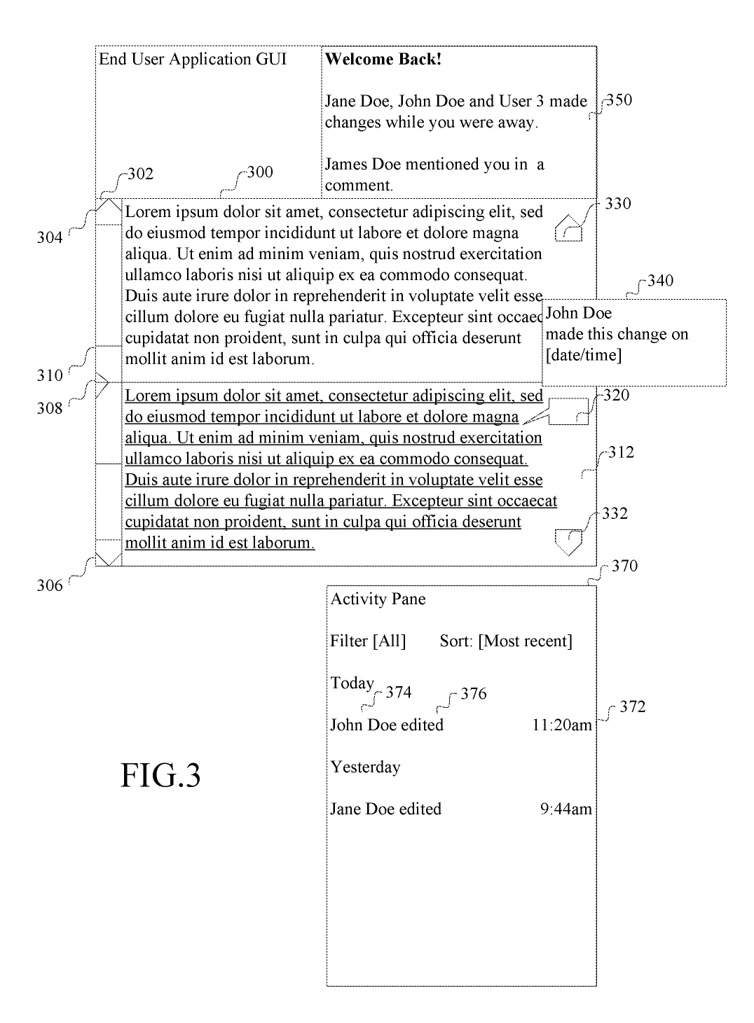

Given an implementation for data indicating content of the electronic document which the end user has accessed, and data indicating changes made to the electronic document, the server computer can determine, when an electronic document is accessed by a given user, which changes have occurred since that user last accessed the electronic document. This information can be used by the end user application to present a graphical user interface which assists the end user in quickly coming up to speed with the changes that have been made to the document. Example aspects of such a graphical user interface will now be described in connection with FIG. 3.

In FIG. 3, an example graphical user interface for an end user application is shown. FIG. 3 illustrates several example features of a graphical user interface which can be used individually or in combination. In this example graphical user interface, a document pane 300 is a primary display area in which the electronic document is presented on a display. The end user computer receives user inputs through one or more input devices, and can associate such inputs with operations with respect to the electronic document in document pane 300, or with respect to other graphical elements in the graphical user interface. The end user computer processes some user inputs to effect modifications to the structure and/or content of the electronic document currently being accessed in the document pane 300. Within the document pane, content that has been changed since the last access by the end user, can be displayed with special formatting such as highlighting or other emphasis. For the purposes of this illustration in FIG. 3, the changed text indicated at 312 is underlined.

The graphical user interface for the end user application can include a scroll bar 302 which represents the length of the document. In response to an input associated with end points 304, 306 of the scroll bar, the content of the document displayed in the document pane can be scrolled. In response to an input associated with a position within the scroll bar, the content of the document displayed in the document pane can be updated to correspond to the selected position. A position indicator 308 along the scroll bar indicates the current position of the displayed content in the document pane 300 with respect to the whole document. Change indicators 310 indicate positions in the document at which a change has been identified. Thus, in response to a user input selecting a change indicator 310 in the scroll bar, the document pane 300 can be updated to show the content of the document corresponding to the position of the selected change indicator 310.

The graphical user interface for the end user application can include previous/next buttons 330, 332. In response to selection of one of these buttons, the document pane 300 can be updated to show the content of the document corresponding to the position of the previous or next new or unseen change, for this end user, in the electronic document.

The graphical user interface for the end user application can include callout indicators 320 in the document pane 300 displayed adjacent to changed content. The callout indicator 320 can be a small icon, for example, which, when manipulated based on user input, can display further information about the change, such as a user identifier for a user that made the change, a time of the change, and/or other information about the change. The graphical user interface for the end user application can have a change data panel 340 which displays such further information about the change, such as a user identifier for a user that made the change, a time of the change, and/or other information about the change. This panel 340 can be displayed, for example in response to a click, touch, mouse over, or other manipulation of a corresponding callout indicator associated with a change.

The graphical user interface for the end user application can include a change summary panel 350. In response to opening an electronic document, when the electronic document is initially displayed in the document pane 300, information summarizing the changes made since the last time the end user opened this document can be displayed in this summary panel 350. Such information can include, for example, a list of the other users that made changes since the electronic document was last accessed.

The graphical user interface for the end user application can include an activity pane 370 in which the end user application displays activity data associated with the electronic document. The activity pane can be displayed nonoverlapping with and immediately adjacent to the document pane, or can be an independent page within the end user application graphical user interface. To assist a user in quickly identifying relevant changes in the electronic document from among the activity data associated with the electronic document, the end user application can provide various settings that control the display of the activity data. Among these, the settings can filter and sort the activity data so as to display only actions relating to modifying content of the electronic document. In the activity pane, activity data representing an action is displayed by generating a graphical representation 372 of the action including an indication 374 of the user that performed the action, which can include a name, user name and/or picture of the user, and a body 376 of the action, which is typically text, but can include other data describing the action as well as other visual appearance parameters related to the action. This graphical representation 372 of an action can be generated using a variety of data accessible through the activity data describing the action. The activity pane can be implemented using other graphical user interface techniques. A modal dialog box, a call-out interface, or small pop-up window, also are examples of a kind of interface that can be shown in the context of the currently accessed electronic document.

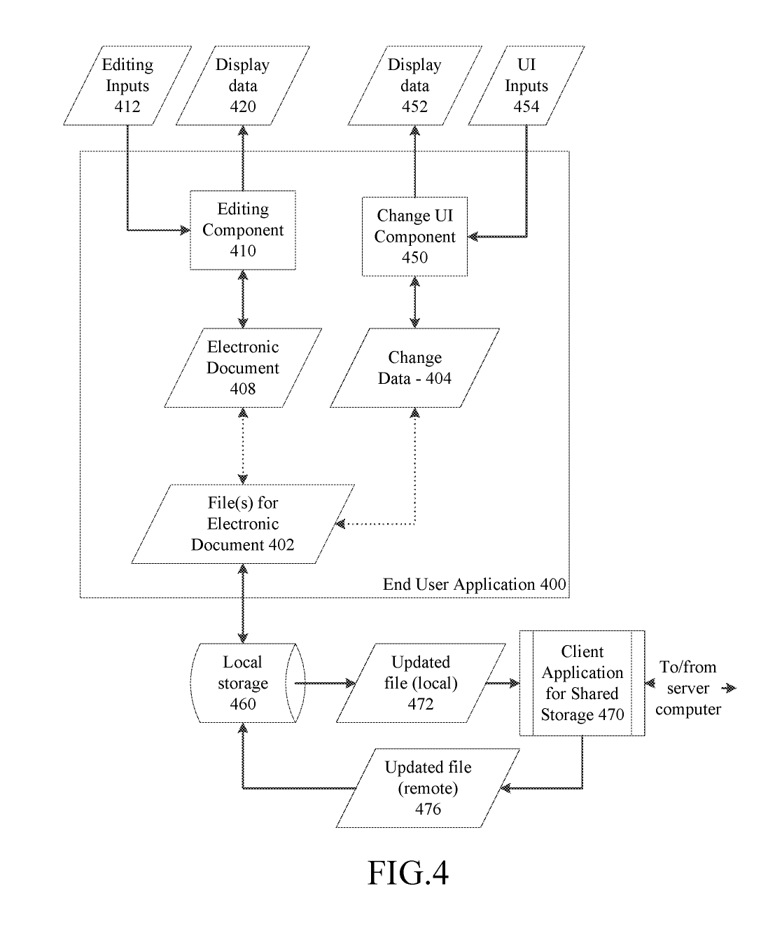

FIG. 4 is a data flow diagram of an example implementation of an end user application 400, running on a client computer, which includes a document pane and one or more graphical user interface elements such as shown in FIG. 3. It should be understood that the implementation as described in connection with FIGS. 3 and 4 is merely an example implementation of an end user application and that a wide variety of other implementations are possible. The end user application 400 has an input to receive one or more files 402 and/or other data defining the electronic document. The end user application generates, in memory, a representations of change data 404 representing changes made to the electronic document since the electronic document was last accessed by the user, based on data received from the shared storage system.

The files 402 may be received from local storage 460 and/or from a shared storage system (such as 100 in FIG. 1). In many shared storage systems, the files in local storage 460 are synchronized with copies of the files on a server computer in the shared storage system. For example, the end user computer can include a client application 470 for shared storage that periodically transmits an updated file 472 of the electronic document from the local storage 460 to the server computer. The server computer then transmits a copy of the electronic document received from one client computer to the other client computers that are using that electronic document. The client application 470 for the shared storage receives an updated file 476 of the electronic document from the server computer, and then updates the copy in local storage 460. The client application 470 can implement a client-side of the protocol with the shared storage system to manage the activity data. The activity service (FIG. 1) on the shared storage system can implement the server side of the protocol.

The end user application processes the structure and content of the electronic document into memory to generate a representation of the electronic document 408, which is edited through an editing component 410. The editing component has inputs to receive user and system inputs 412 involved in the editing and storing of the electronic document, and outputs to provide display data 420 representing the electronic document being edited, and outputs to provide a modified electronic document back to storage as a file 402 upon saving. The end user application displays the display data 420 through the graphical user interface, e.g., displaying the structure and content of the electronic document in a document pane 300, which can include one or more displays and/or other output devices.

A change UI component 450 manages presentation of and interaction with change data 404 representing the changes in the content of the electronic document since the end user last accessed the electronic document. For example, the change UI component generates display data 452 for one or more of the graphical user interface elements for the change data to be displayed in the graphical user interface. Also, the change UI component can be responsive to inputs 454 with respect to these graphical user interface elements to update the display of those elements and to update the display of the electronic document, e.g., in the document pane, based on navigation through the electronic document in response to such inputs 454.

It should be understood that the foregoing is just one example implementation of a collaborative editing system. Implementations of such systems will vary at least in the type of data stored, in the way such data is stored, and in how such data is processed by end user applications to provide navigation tools through graphical user interface elements.

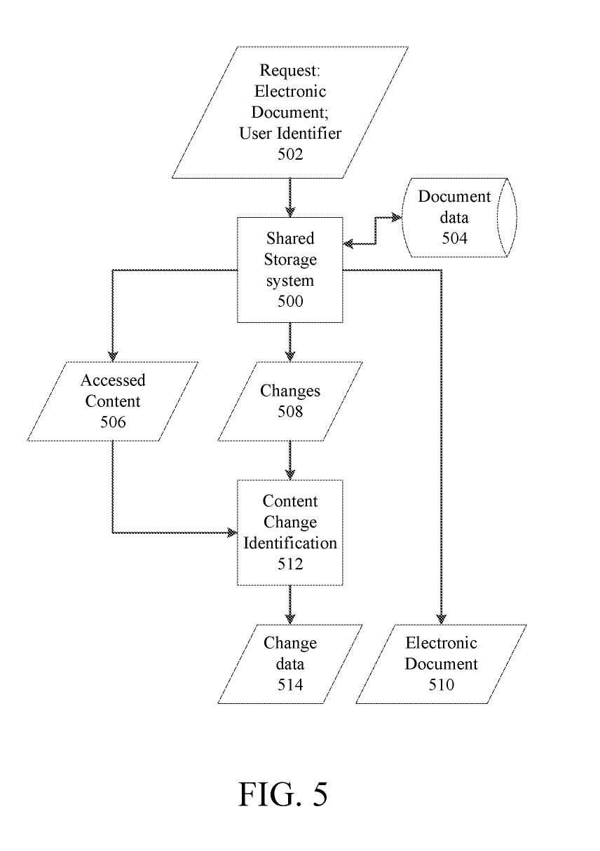

Turning now to FIG. 5, a dataflow diagram of an example implementation of components on the server computer to generate and provide such change data will now be described.

A shared storage system 500 receives a request 502 from an end user application on a client computer to access an electronic document. The request includes, among other data, an indication of the electronic document to be accessed, such as a file name, and an indication of a user, such as a user name, who is accessing the electronic document. After authenticating (not illustrated) a user to access the electronic document, and in response to the request for an electronic document, the shared storage system accesses document data 504 for the electronic document. The shared storage system obtains an indication of content of the electronic document which the end user has accessed (accessed content 506), information about changes made to the electronic document (changes 508) and the electronic document 510.

The indication of content of the electronic document which the end user has accessed (accessed content 506), information about changes made to the electronic document (changes 508) are inputs to a content change identification module 512, which computes change data 514. The change data is data that represents the changes in the content of the electronic document since the time the end user last accessed the electronic document, including a location in the electronic document of the change, the corresponding changed content, a user associated with the change and a time associated with the change. How the change data is computed depends on the implementation of data structures for the indication of content of the electronic document which the end user has accessed and for the information about changes made to the electronic document.

The shared storage system 500 thus provides, in response to the request 502, the electronic document 510 and change data 514 to the end user application on the client computer.

Example implementations of operations of a computer system implementing these techniques will now be described.

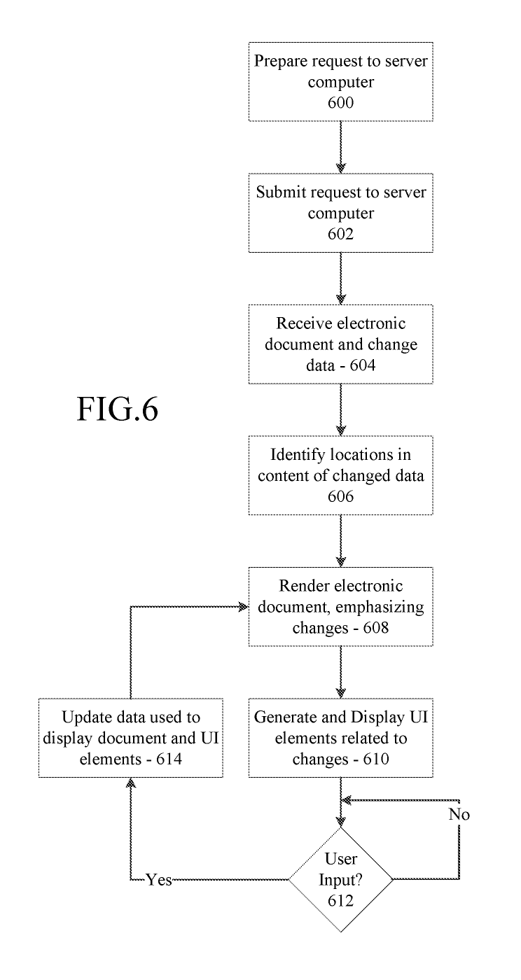

FIG. 6 is a flowchart of operation of an example implementation of opening an electronic document by an end user application.

In response to an input from the end user, the end user application prepares 600 a request to the server computer including an identifier of an electronic document and an identifier of the end user. The end user application submits 602 this request to the server computer. If no error occurs, the end user application receives 604 the electronic document to be opened and change data related to the electronic document.

The end user application processes the electronic document and the change data to identify 606 locations in the electronic document of changes to the content. Given these identified locations, the electronic document is rendered 608 with the changed content at the identified locations emphasized in some manner, such as highlighting.

The change data also is used to generate and display 610 one or more graphical user interface elements useful for viewing information about the changes and/or navigating among changes. In response to user input (612) manipulating such graphical user interface elements, the data used to render the electronic document and/or the graphical user interface element can be updated 614. For example, a current cursor position within the electronic document may be changed, additional data about a change may be prepared for display, or a view of the rendered electronic document may be changed. The electronic document may be re-rendered and displayed (608), and the graphical user interface elements may be re-rendered and displayed (610).

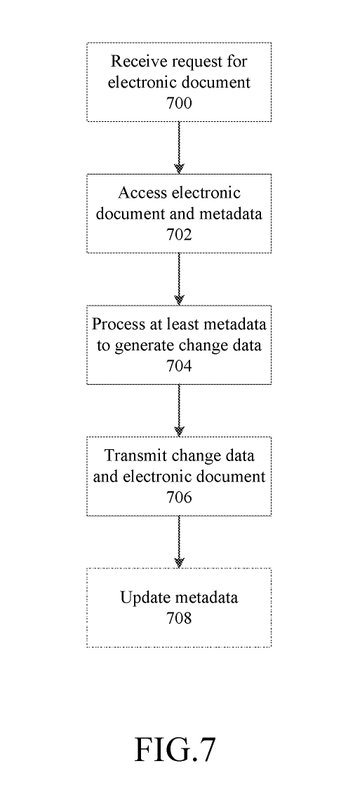

Turning now to FIG. 7, a flowchart of operation of an example implementation of the shared storage system will now be described. The shared storage system receives 700 a request for an electronic document from an end user application on an end user computer. The shared storage system accesses 702 the electronic document and its metadata which includes data structures for the indication of content of the electronic document which the end user has accessed and for the information about changes made to the electronic document.

The shared storage system processes 704 at least the metadata of the electronic document to generate change data from the data file into memory for processing into the activity store. The shared storage system transmits 706 the change data and the electronic document to the end user computer that requested the change data.

At this time, the server computer can optionally update (708) the metadata about the end user's last access to this electronic document. For example, a time stamp can be stored indicating that the end user accessed the electronic document. This metadata about the end user's last access to this electronic document can be updated at the time the electronic document is opened for read, or opened for write, or closed, or saved, depending on implementation details. In implementations where the end user application tracks which changes have been viewed by the end user, such information can be used by the server computer when the electronic document is closed or saved to update the metadata about the end user's last access.

There are several ways in which the server computer can determine the change data depending on the data structures for the indication of content of the electronic document which the end user has accessed and for the information about changes made to the electronic document.

For example, the indication of content of the electronic document which the end user has accessed can be a combination of content identifiers for an electronic document and time stamps when the end user last accessed the content associated with the content identifiers. The changes can be determined by identifying all content identifiers for content in the electronic document having time stamps later than the time stamps for those content identifiers as stored for this end user.

As another example, the indication of content of the electronic document which the end user has accessed can be a list of save identifiers for an electronic document. The changes can be determined by identifying all save identifiers for content in the electronic document which are not in the list of save identifiers as stored for this end user.

As another example, the indication of content of the electronic document which the end user has accessed can be a time stamp of the last access. The changes can be determined by comparing content of a most up to date version of the electronic document with content of a version of the electronic document immediately preceding or identical to the time stamp stored for this end user. The end user application can receive the version of the electronic document immediately preceding or identical to the time stamp stored for this end user, and the changes to be applied to that version. Similarly, the changes can be determined by accessing all revisions from a revision history which occur after the time stamp for the given user. The end user application can receive the version of the electronic document immediately preceding or identical to the time stamp stored for this end user, and the set of revisions selected from the revision history occurring after that time stamp.

As another example, the indication of content of the electronic document which the end user has accessed can be a time stamp of the last access. The changes can be determined by identifying all actions in the activity data for the electronic document resulting changes to content of the electronic document and occurring after the time stamp stored for this end user. In such an implementation, the change data provided by the shared storage system can be the activity data and the time stamp stored for the end user, and the end user application can process and filter the activity data to provide different views of the change data.

As another example, the indication of content of the electronic document which the end user has accessed can be an activity identifier for an action in the activity data for the electronic document which was last accessed for the end user. The changes can be determined by identifying actions in the activity data for the electronic document which result in changes to content of the electronic document and which have activity identifiers occurring after the activity identifier stored for this end user. In such an implementation, the change data provided by the shared storage system can be the activity data and the activity identifier stored for the end user, and the end user application can process and filter the activity data to provide different views of the change data.

By generating the change data in this manner, the end user application allows the user to quickly navigate the electronic document and catch up on changes made to that electronic document. Additionally, by generating the change data at the server computer, an end user can access an electronic document using different end user devices and be provided change information based on the last access to the electronic document regardless of the end user device from which the electronic document was accessed. The end user application on the device can present the electronic document with information indicating the content which that end user has not yet accessed. The end user application also can provide navigational and visual aids to an end user, allowing the user to quickly navigate the electronic document and catch up on changes made to that electronic document. Processing by the end user application of the electronic document, due to navigation and rendering in response to end user input, can be reduced by indicating the content which that end user has not yet accessed. Processing by the end user application of the electronic document also can be reduced by generating the change data on the server computer.

Having now described an example implementation, FIG. 8 illustrates an example of a computer with which components of the computer system of the foregoing description can be implemented. This is only one example of a computer and is not intended to suggest any limitation as to the scope of use or functionality of such a computer.

The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones including but not limited to “smart” phones, personal data assistants, voice recorders), server computers, multiprocessor systems, microprocessor-based systems, programmable consumer electronics, networked personal computers, minicomputers, mainframe computers, and distributed computing environments that include any of the above types of computers or devices, and the like.

With reference to FIG. 8, a computer 800 includes a processing system comprising at least one processing unit 802 and at least one memory 804. The processing unit 802 can include multiple processing devices; the memory 804 can include multiple memory devices. A processing unit 802 comprises a processor which is logic circuitry which responds to and processes instructions to provide the functions of the computer. A processing device can include one or more processing cores (not shown) that are multiple processors within the same logic circuitry that can operate independently of each other. Generally, one of the processing units in the computer is designated as a primary processor, typically called the central processing unit (CPU). One or more additional co-processing units 820, such as a graphics processing unit (GPU), also can be present in the computer. A co-processing unit comprises a processor that performs operations that supplement the central processing unit, such as but not limited to graphics operations and signal processing operations.

The memory 804 may include volatile computer storage devices (such as dynamic random access memory (DRAM) or other random access memory device), and non-volatile computer storage devices (such as a read-only memory, flash memory, and the like) or some combination of the two. A nonvolatile computer storage device is a computer storage device whose contents are not lost when power is removed. Other computer storage devices, such as dedicated memory or registers, also can be present in the one or more processors. The computer 800 can include additional computer storage devices (whether removable or non-removable) such as, but not limited to, magnetically-recorded or optically-recorded disks or tape. Such additional computer storage devices are illustrated in FIG. 1 by removable storage device 808 and non-removable storage device 810. Such computer storage devices 808 and 810 typically are nonvolatile storage devices. The various components in FIG. 8 are generally interconnected by an interconnection mechanism, such as one or more buses 830.

A computer storage device is any device in which data can be stored in and retrieved from addressable physical storage locations by the computer by changing state of the device at the addressable physical storage location. A computer storage device thus can be a volatile or nonvolatile memory, or a removable or non-removable storage device. Memory 804, removable storage 808 and non-removable storage 810 are all examples of computer storage devices. Some examples of computer storage devices are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage devices and communication media are distinct categories, and both are distinct from signals propagating over communication media.

Computer 800 may also include communications connection(s) 812 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal. By way of example, and not limitation, communication media includes wired media, such as metal or other electrically conductive wire that propagates electrical signals or optical fibers that propagate optical signals, and wireless media, such as any non-wired communication media that allows propagation of signals, such as acoustic, electromagnetic, electrical, optical, infrared, radio frequency and other signals.

Communications connections 812 are devices, such as a wired network interface, wireless network interface, radio frequency transceiver, e.g., Wi-Fi 870, cellular 874, long term evolution (LTE) or Bluetooth 872, etc., transceivers, navigation transceivers, e.g., global positioning system (GPS) or Global Navigation Satellite System (GLONASS), etc., transceivers, and network interface devices 876, e.g., Ethernet, etc., or other device, that interface with communication media to transmit data over and receive data from signal propagated over the communication media.

The computer 800 may have various input device(s) 814 such as a pointer device, keyboard, touch-based input device, pen, camera, microphone, sensors, such as accelerometers, thermometers, light sensors and the like, and so on. The computer 800 may have various output device(s) 816 such as a display, speakers, and so on. Such devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

The various computer storage devices 808 and 810, communication connections 812, output devices 816 and input devices 814 can be integrated within a housing with the rest of the computer, or can be connected through various input/output interface devices on the computer, in which case the reference numbers 808, 810, 812, 814 and 816 can indicate either the interface for connection to a device or the device itself

A computer generally includes an operating system, which is a computer program that, when executed, manages access, by other applications running on the computer, to the various resources of the computer. There may be multiple applications. The various resources include the memory, storage, input devices and output devices, such as display devices and input devices as shown in FIG. 1. To manage access to data stored in nonvolatile computer storage devices, the computer also generally includes a file system which maintains files of data. A file is a named logical construct which is defined and implemented by the file system to map a name and a sequence of logical records of data to the addressable physical locations on the computer storage device. Thus, the file system hides the physical locations of data from applications running on the computer, allowing applications to access data in a file using the name of the file and commands defined by the file system. A file system generally provides at least basic file operations such as creating a file, opening a file, writing a file or its attributes, reading a file or its attributes, and closing a file.

The various modules, tools, or applications, and data structures and flowcharts of FIGS. 1-7, as well as any operating system, file system and applications on a computer in FIG. 8, can be implemented using one or more processing units of one or more computers with one or more computer programs processed by the one or more processing units.

A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct or configure the computer to perform operations on data, or configure the computer to implement various components, modules or data structures.

Alternatively, or in addition, the functionality of one or more of the various components described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Accordingly, in one aspect, a shared storage system includes a server computer. The server computer comprises a network interface configured to connect the shared storage system to a computer network connected to a plurality of end user computers, a computer storage device, and a processing device. The processing device executes computer program code that configures the server computer to be comprising a file system. The file system is operative to provide access to a plurality of electronic documents in the computer storage device. The server computer is responsive to a request from an end user application on an end user computer for an electronic document. The request includes at least an identifier of the electronic document and an identifier of an end user. In response to the request, the server computer accesses data indicating content of the electronic document which the end user has accessed, and accesses data describing changes made to the electronic document. The server computer determines changes made to the electronic document since the end user accessed the electronic document. The server computer transmits, to the end user computer, the electronic document and data describing the changes made to the electronic document since the end user accessed the electronic document. Another aspect is a method performed by such a server computer.

In one aspect, a computer system includes a server computer and an end user computer. The server computer comprises a network interface configured to connect the shared storage system to a computer network connected to a plurality of end user computers, a computer storage device, and a processing device. The processing device executes computer program code that configures the server computer to be comprising a file system. The file system is operative to provide access to a plurality of electronic documents in the computer storage device. The server computer is responsive to a request from an end user application on an end user computer for an electronic document. The request includes at least an identifier of the electronic document and an identifier of an end user. In response to the request, the server computer accesses data indicating content of the electronic document which the end user has accessed, and accesses data describing changes made to the electronic document. The server computer determines changes made to the electronic document since the end user accessed the electronic document. The server computer transmits, to the end user computer, the electronic document and data describing the changes made to the electronic document since the end user accessed the electronic document. Another aspect is a method performed by such a computer system.

In one aspect, an end user computer comprises a network interface configured to connect the end user computer to the computer network, a computer storage device, and a processing device. The processing device executes computer program code that configures the end user computer to be comprising an end user application operative to edit electronic documents in the computer storage device. The end user application includes an editing component, operative to render and display a selected portion of the electronic document and modify content and structure of the electronic document in response to user input, and a change user interface component, operative to present one or more graphical user interface elements based on at least the data describing the changes made to the electronic document since the end user accessed the electronic document. Another aspect is a method performed by such an end user computer.

In another aspect a computer system includes a means for storing data indicating content of electronic documents which end users have accessed and data describing changes made to the electronic document, and means for determining, for an end user and an electronic document, changes made to the electronic document since the end user accessed the electronic document.

In another aspect a computer system includes a means for storing data indicating content of electronic documents which end users have accessed and data describing changes made to the electronic document, and means for determining, for an end user and an electronic document, changes made to the electronic document since the end user accessed the electronic document, and means for presenting one or more graphical user interface elements based on at least the data describing the changes made to the electronic document since the end user accessed the electronic document.

In another aspect a computer system includes a means for receiving, for an end user and an electronic document, data describing changes made to the electronic document since the end user accessed the electronic document, and means for presenting one or more graphical user interface elements based on at least the data describing the changes made to the electronic document since the end user accessed the electronic document.

In any of the foregoing aspects, the data can indicate content of the electronic document which the end user has accessed includes a time stamp associated with a last access by the end user of the electronic document.

In any of the foregoing asepects, the data can indicate content of the electronic document which the end user has accessed includes save identifiers from the electronic document associated with the last access by the end user.

In any of the foregoing aspects, the data representing changes to the electronic document can include a revision history including a plurality of revisions to the electronic document, wherein each revision has a time stamp.

In any of the foregoing aspects, the data representing changes to the electronic document can include a plurality of versions of the electronic document, wherein each version has a time stamp.

In any of the foregoing aspects, the data representing changes to the electronic document can include save identifiers associated with content in the electronic document indicating when the content was saved.

In any of the foregoing aspects, the data representing changes to the electronic document can include activity data associated with the electronic document including data indicating actions taken by users with respect to content of the electronic document.

In any of the foregoing aspects, the graphical user interface element comprises a scroll bar adjacent a document pane indicating locations in the electronic document at which changes in the content occur.

In any of the foregoing aspects, the graphical user interface element comprises a list of user identifiers associated with the changes made to the electronic document since the end user accessed the electronic document.

In any of the foregoing aspects, the graphical user interface element comprises a callout, display adjacent changed text in a document pane, wherein in response to user input with respect to the callout element, the end user application displays an indication of a user associated with the changed text.

In any of the foregoing aspects, the graphical user interface element comprises an activity pane displaying a graphical representation of actions associated with the changes made to the electronic document since the end user accessed the electronic document.

In any of the foregoing aspects, the graphical user interface element comprises emphasize changed text in a document pane.

In another aspect, an article of manufacture includes at least one computer storage medium, and computer program instructions stored on the at least one computer storage medium. The computer program instructions, when processed by a processing system of a computer, the processing system comprising one or more processing units and storage, configures the computer as set forth in any of the foregoing aspects and/or performs a process as set forth in any of the foregoing aspects.

Any of the foregoing aspects may be embodied as a computer system, as any individual component of such a computer system, as a process performed by such a computer system or any individual component of such a computer system, or as an article of manufacture including computer storage in which computer program instructions are stored and which, when processed by one or more computers, configure the one or more computers to provide such a computer system or any individual component of such a computer system.

It should be understood that the subject matter defined in the appended claims is not necessarily limited to the specific implementations described above. The specific implementations described above are disclosed as examples only.

What is claimed is:

1. A shared storage system, comprising:
a server computer comprising:
a network interface configured to connect the shared storage system to a computer network connected to a plurality of end user computers,
a computer storage device, and
a processing device;
the processing device executing computer program code that configures the server computer to be comprising:
a file system operative to provide access to a plurality of electronic documents in the computer storage device,
wherein the server computer is operative, in response to a request from an end user application on an end user computer for an electronic document, the request including at least an identifier of the electronic document and an identifier of an end user, to:
access data indicating content of the electronic document which the end user has accessed;
access data describing changes made to the electronic document;
determine changes made to the electronic document since the end user accessed the electronic document; and
transmit, to the end user computer, the electronic document and data describing the changes made to the electronic document since the end user accessed the electronic document.

2. The shared storage system of claim 1, wherein the data indicating content of the electronic document which the end user has accessed includes a time stamp associated with a last access by the end user of the electronic document.

3. The shared storage system of claim 1, wherein the data indicating content of the electronic document which the end user has accessed includes save identifiers from the electronic document associated with the last access by the end user.

4. The shared storage system of claim 2, wherein the data representing changes to the electronic document includes a revision history including a plurality of revisions to the electronic document, wherein each revision has a time stamp.

5. The shared storage system of claim 2, wherein the data representing changes to the electronic document includes a plurality of versions of the electronic document, wherein each version has a time stamp.

6. The shared storage system of claim 3, wherein the data representing changes to the electronic document includes save identifiers associated with content in the electronic document indicating when the content was saved.

7. The shared storage system of claim 2, wherein the data representing changes to the electronic document includes activity data associated with the electronic document including data indicating actions taken by users with respect to content of the electronic document.

8. A computer system, comprising:
a server computer comprising:
a network interface configured to connect the shared storage system to a computer network,
a computer storage device, and
a processing device, the processing device executing computer program code that configures the server computer to be comprising:
a file system operative to provide access to a plurality of electronic documents in the computer storage device,
wherein the server computer is operative, in response to
access data indicating content of the electronic document which the end user has accessed;
access data describing changes made to the electronic document.
determine changes made to the electronic document since the end user accessed the electronic document;
transmit, to the end user computer, the electronic document and data describing the changes made to the electronic document since the end user accessed the electronic document;
the end user computer comprising:
a network interface configured to connect the end user computer to the computer network,
a computer storage device, and
a processing device;
the processing device executing computer program code that configures the end user computer to be comprising:
an end user application operative to edit electronic documents in the computer storage device, and including:
an editing component, operative to render and display a selected portion of the electronic document and modify content and structure of the electronic document in response to user input; and
a change user interface component, operative to present one or more graphical user interface elements based on at least the data describing the changes made to the electronic document since the end user accessed the electronic document.

9. The computer system of claim 8, wherein the data indicating content of the electronic document which the end user has accessed includes a time stamp associated with a last access by the end user of the electronic document.

10. The computer system of claim 8, wherein the data indicating content of the electronic document which the end user has accessed includes save identifiers from the electronic document associated with the last access by the end user.

11. The computer system of claim 9, wherein the data representing changes to the electronic document includes a revision history including a plurality of revisions to the electronic document, wherein each revision has a time stamp.

12. The computer system of claim 9, wherein the data representing changes to the electronic document includes a plurality of versions of the electronic document, wherein each version has a time stamp.

13. The computer system of claim 10, wherein the data representing changes to the electronic document includes save identifiers associated with content in the electronic document indicating when the content was saved.

14. The computer system of claim 9, wherein the data representing changes to the electronic document includes activity data associated with the electronic document including data indicating actions taken by users with respect to content of the electronic document.

15. A computer comprising:
a computer storage device and a processing device;
the processing device executing computer program code that configures the computer to be comprising:
an end user application operative to edit electronic documents in the computer storage device, and including:
an editing component, operative to render and display a selected portion of the electronic document and modify content and structure of the electronic document in response to user input; and
a change user interface component, operative to present one or more graphical user interface elements based on at least the data describing the changes made to the electronic document since the end user accessed the electronic document.

16. The computer of claim 15, wherein the graphical user interface element comprises a scroll bar adjacent a document pane indicating locations in the electronic document at which changes in the content occur.

17. The computer of claim 15, wherein the graphical user interface element comprises a list of user identifiers associated with the changes made to the electronic document since the end user accessed the electronic document.

18. The computer of claim 15, wherein the graphical user interface element comprises a callout, display adjacent changed text in a document pane, wherein in response to user input with respect to the callout element, the end user application displays an indication of a user associated with the changed text.

19. The computer of claim 15, wherein the graphical user interface element comprises an activity pane displaying a graphical representation of actions associated with the changes made to the electronic document since the end user accessed the electronic document.

20. The computer of claim 15, wherein the graphical user interface element comprises emphasize changed text in a document pane.
